(19) United States
(12) Patent Application Publication
(10) Pub. No.: US 2018/0010430 A1
(43) Pub. Date: Jan. 11, 2018

(54) PRODUCTION MONITORING - MULTI VOLUME DYNAMIC SEMI STEADY PARAMETRIC MODEL

(71) Applicant: PRODUCTION MONITORING AS, Bergen (NO)

(72) Inventor: Arild Bøe, Bergen (NO)

(21) Appl. No.: 15/552,481

(22) PCT Filed: Feb. 20, 2015
(86) PCT No.: PCT/NO2015/050037

§ 371 Date: Aug. 21, 2017

(51) Int. Cl. E21B 43/12; E21B 43/14; E21B 49/00; G01V 1/42

(52) U.S. Cl. CPC E21B 43/12; G01V 1/42; E21B 43/14; E21B 49/008

(57) ABSTRACT

A production monitoring system comprises a plurality of production and injection wells coupled in operation to sensors for measuring physical processes occurring in operation in the production and injection wells and generating corresponding measurement signals for computing software. The computing hardware is operable to execute software products to analyze said measurement signals to abstract a parameter representation of said measurement signals, and to apply said parameters to estimate at least one parametric model of said plurality of injection and production wells, and to employ one of these models for monitoring the system.

### TECHNICAL FIELD OF INVENTION

The present invention relates to production monitoring systems for monitoring production and injection from a configuration of oil and/or gas wells. Moreover, the invention concerns methods of monitoring said oil and/or gas wells for controlling operation and forecasting of the well injection and production. Furthermore, the invention relates to software products recorded on machine-readable data storage media, wherein the software products are executable upon computing hardware for implementing the aforementioned methods.

### BACKGROUND OF THE INVENTION

With reference to FIG. 1, a contemporary oil and/or gas production system includes multiple production and injection wells 80 through corresponding boreholes 20 penetrating into an underground geological formation 30 bearing an oil deposit 40 and/or a gas deposit 50. In general a deposit 40, 50 comprises more or less water in addition to oil and/or gas, or even just water. Often, the geological formation 30 corresponds to one or more anticlines which form a natural containment for the oil deposit 40 and/or gas deposit 50. The geological formation 30 is usually heterogeneous. The deposits 40, 50 are often contained within regions of porous rock with multiple fissures, cavities and structural weaknesses which define maximum pressures which can be sustained by the regions during oil and/or gas extraction. The borehole 20 itself is often introducing a structural weakness. Excessive pressure applied to the geological formation 30, for example via water injection, can risk causing multiple unwanted fractures, namely “out of zone” fractures.

In the present document some expressions are defined as follows:

A productivity parameter of a reservoir deposit is a fluid flow of oil and/or gas from a reservoir deposit divided by a differential pressure resulting from the fluid flow.

An injectivity parameter of a well is a similar parameter as said productivity parameter and is a fluid flow of water into a reservoir deposit divided by a differential pressure resulting from the fluid flow.

A storativity parameter of a reservoir deposit is a volume change in said reservoir deposit divided by the pressure change in the reservoir deposit.

A connectivity parameter between two deposits in the underground is a fluid flow between the first and the second of said deposits divided by the differential pressure between said two deposits. This parameter reflects potential hydraulic communication between the two deposits.

Contemporary industry practice is to decide upon productivity, injectivity and reservoir pressure from episodic tests, i.e. through measuring coherent values of production rates and pressures.

In the patent application WO2012/039626 (Arild Bøe, Epsis AS), monitoring of a production well is done by identifying temporally slow and temporally fast processes and abstract a parameter representation that is representative of said slow processes and said fast processes to be used for controlling operation of the system.

### SUMMARY OF THE INVENTION

The present invention seeks to provide an improved production monitoring system for providing enhanced control of complex oil and/or gas production systems.

The present invention seeks to provide an improved method of monitoring a complex production system comprising a plurality of producers and injectors operating in association with a heterogeneous porous medium.

The present invention uses an alternative method for parameter estimation:
The hydraulic response of a sub-surface production system comprising a number of participating deposits is estimated based upon pressures and production rates as measured variables instead of pressure integrals and production rate dynamics.
A parametric model of the production system is used for describing the behavior of the production system. A parameter estimation procedure, such as a Kalman filter, is used to find the model parameters in the parametric representation. The production system involves a well system comprising at least one production well. This production system may comprise a deposit not penetrated by wells but in hydraulic communication with a deposit with a production well or an injection well. The parametric representation is then employed and evaluated based upon measured real time data of flow and pressure.
By using an estimation method such as a Kalman filter, all the desired parameters are abstracted as a set of parameters adapted optimally to each other as opposed to traditional modeling where each parameter is developed one by one and thus are not tuned optimally to each other.
Provided the evaluation concludes that the model of the production system is not sufficiently accurate, a more complicated parametric representation is considered, comprising maybe a additional deposit not penetrated by wells but in hydraulic communication with other deposits. This parametric representation is then evaluated,
based upon the monitored data and the process of selecting a new parametric representation and then evaluating it may be repeated until a sufficiently accurate parametric representation is identified. The simplest parametric representation identified as sufficiently accurate is then used for estimating all parameters defining said representation of the production system.
If, after some time has passed, the parametric representation is no longer able to provide a sufficiently accurate reproduction of the measured flow and pressure data, another parametric representation is evaluated and the above method is repeated. Often this new parametric representation is more complicated than the previous one.
More than one parametric representation may be developed and evaluated in parallel.

Because the underground is dynamic and influenced by e.g. the process of retrieving oil and gas from deposits in the underground, the parametric representation used for the production monitoring system is expected to be corrected or altered during the lifetime of the production system. When used for production monitoring, the parametric representation is continuously evaluated if being sufficiently accurate. It is not necessary to stop the production in order to get parameters for the evaluation of the parametric model.

By using the present invention, some important parameters may be estimated continuously along a timeline with no need to interrupt production:

Parameters of a well
The productivity of a producing well and the injectivity of an injecting well as functions of time. Through this, one may also continuously monitor alterations of these. Alterations may stem from changes in the flow of fluid or changes in the hydraulic communication properties in a deposit close to the well.

Parameters of a deposit
Storativity of each deposit involved, i.e. volume of fluid times compressibility
Reservoir pressure of each deposit involved

Parametric representation of the production system
The number of deposits involved in the parametric representation
Identifying deposits involving hydraulic communication between each other as well as its strength
The extent of cross current between the involved deposits

This invention is useful for technical reasons:
Continuous control with key parameters in order to optimize the production from a well or reservoir
The ability to monitor how these key parameters change over time and thereby also the ability to optimize related to changed conditions

This invention is useful for operational reasons:
Improved background at any time to optimize related to changed external conditions including limitations
Improved reliable prognoses of future production capacity
Extended possibility for using scenario technics like “what-if” in order to analyze
Consequences of different actions before the actual actions are performed

### Problems to be Solved by the Invention

With the WO2012039626 application, production monitoring is done by identifying a representation of temporally slow and temporally fast processes. In order to identify the parameters of these temporally slow and temporally fast processes, sensors for measuring physical processes occurring in operation in the injection and production wells for generating corresponding measurement signals that are used to apply a temporal analysis.

A problem with that invention is that it depends on executing periodical tests, involving interruption of the production, in order to get sufficient measurement signals to maintain the representation of the processes sufficiently well.

The present invention does not depend upon periodical tests or shutdowns in order to maintain a good representation of the well. The invention can be utilized during normal operation of the configuration of oil and/or gas wells, i.e. without planned or not planned interruption of the production. On the other hand, when such events happen, added information from the behavior of the system may be utilized to improve or verify the parametric representation or model being used to monitor the production system.

### Means to Solve the Problems

According to a first aspect of the present invention, there is provided a production monitoring system as defined in claim 1.

A production monitoring system for a configuration of oil and/or gas wells, said configuration comprising production and injection wells coupled in operation to sensors for measuring physical processes during normal operation of the production well(s) and injection well(s) and generating corresponding measurement signals for computing hardware, wherein said computing hardware is operable to execute software products for processing said signals, where the software products are adapted for said computing hardware to analyze said measurement signals to abstract at least one parametric representation of said configuration of oil and/or gas wells comprising the following parameters:
one instantaneous productivity parameter for each production well;
one instantaneous injectivity parameter for each injection well;
one instantaneous storativity parameter for each deposit; and
one instantaneous connectivity parameter for the hydraulic communication between each pair of deposits in hydraulic communication with each other and to employ said at least one parametric representation for monitoring the configuration of oil and/or gas wells.

Optionally, the production monitoring system analysis involves applying a parametric model with an estimation algorithm analyzing characteristics of said measurement signals by using said measurement signals, and determining deviations between said measurement signals and corresponding modeled measurement signals for identifying said parameters for the model.

Optionally, the estimation algorithm employs a Kalman filter.

More optionally, the at least one parametric model comprises one of more deposits not penetrated by boreholes, in addition to the plurality of deposits comprising production and injection well(s).

More optionally, a production monitoring system wherein said at least one parametric model comprises at least two models and the model to be used to model the production monitoring system is selected as the simplest one estimating a correlation coefficient between a measured value and an estimated value of a set of variables in the model sufficiently accurate i.e. with a correlation coefficient greater than 0.93.

Still more optionally, a production monitoring system wherein the correlation coefficient is greater than 0.95.

More optionally, a production monitoring system wherein the parametric model to be used to model the production monitoring system is selected by a software product.

### BRIEF DESCRIPTION OF THE DRAWINGS

Embodiments of the present invention will now be described, by way of example only, with reference to the following drawings wherein:

FIG. 1 is an illustration of a contemporary oil and/or gas production system including multiple wells and boreholes;

FIG. 2 is an illustration of a contemporary oil and/or gas production system including multiple wells and boreholes and comprising deposits without any borehole;

FIG. 3 is an illustration of a contemporary temporal characteristic of the system of FIG. 2 subject to periods of quasi-constant production interspersed with well testing;

FIG. 4 is a simple representation of a pair of wells of the system of FIG. 1;

FIG. 5 is a more complex representation of a pair of wells of the system of FIG. 2;

FIG. 6 is a complex representation of the system of FIG. 2 with n pairs of injection and production wells as well as deposits without any well;

FIG. 7 is an illustration of functions included within a method of monitoring and controlling the system of FIG. 2; and

FIG. 8 is an illustration of the system of FIG. 2 coupled to computing hardware operable to execute software products for implementing a method pursuant to the present invention.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE INVENTION

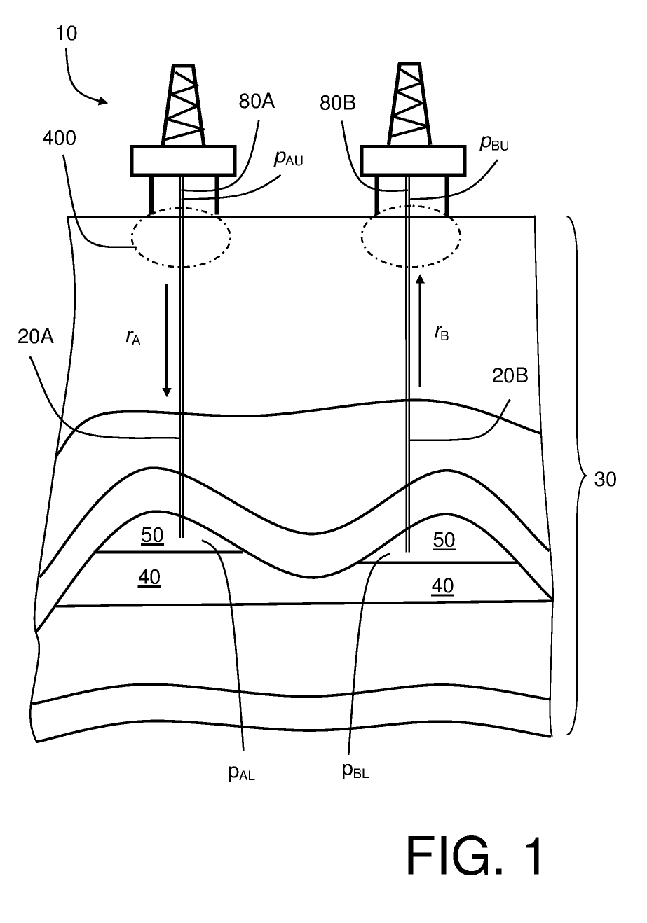

Referring to FIG. 1, the boreholes 20A, 20B are associated with wells 80A, 80B respectfully. The well 80A is employed to inject fluid, whereas the well 80B is employed to receive fluid from the geological formation 30 comprising oil and/or gas. In the present document, a well 80 comprises the line from a wellhead through a borehole 20 and to a deposit 40, 50. An injection rate is denoted r_{A} while a production rate is denoted r_{B}. The geological formation 30 is usually heterogeneous in spatial nature.

In the underground, oil and gas deposits are located in deposits 30, 40 that may be in heterogeneous communication with each other. These deposits 30, 40 have production wells 80B, injection wells 80A and often also one or more deposits 30, 40 without wells but nevertheless communicate with the other deposits.

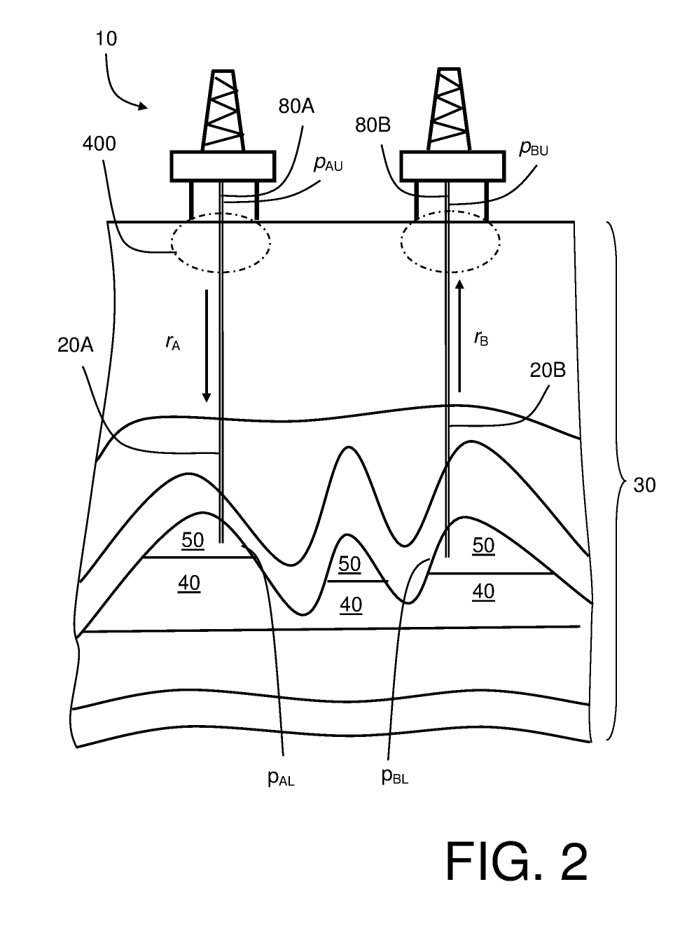

FIG. 2 depicts a more detailed well system than in FIG. 1, now also including a deposit 50 not penetrated by any wells but in hydraulic communication with the rest of the well system. This embodiment enables a more correct parametric representation of a well system.

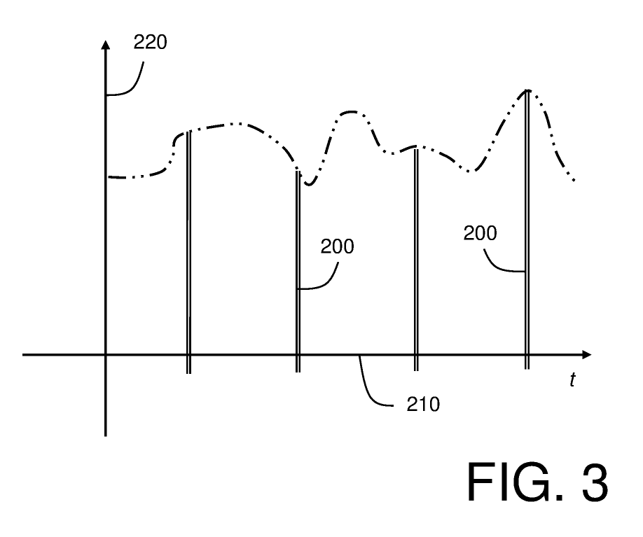

In FIG. 3, an abscissa axis 210 denotes time t, and an ordinate axis 220 denotes a parameter of the system, for example well-head proximate pressure. The tests 200 conventionally involve applying a step perturbation change in flow rate r by applying a step change in one or more of the flow resistance h_{A} and/or h_{B}, or by changing the proximate wellhead pressures p_{AU}, p_{BU} A response of the system to the step change perturbation at each well 80 provides insight into the flow resistances k_{A}, k_{B}, and also the capacity c_{G} for each well 80, namely for a portion of the geological region 30 associated with the wells 80A, 80B. For example, a time constant associated with an exponential pressure response to a step change in flow rate r provides an indication of the capacity c_{G}, and a magnitude of the pressure response provides an indication of the flow resistances k_{A}, k_{B} associated with the wells 80. However, such a quasi-constant measurement is only approximate when the geological formation 30 is extensive, porous and is intersected by multiple sets of boreholes 20. Such tests are not necessary for implementing the present invention, but conveniently may improve the parameters involved in the estimated parametric representation.

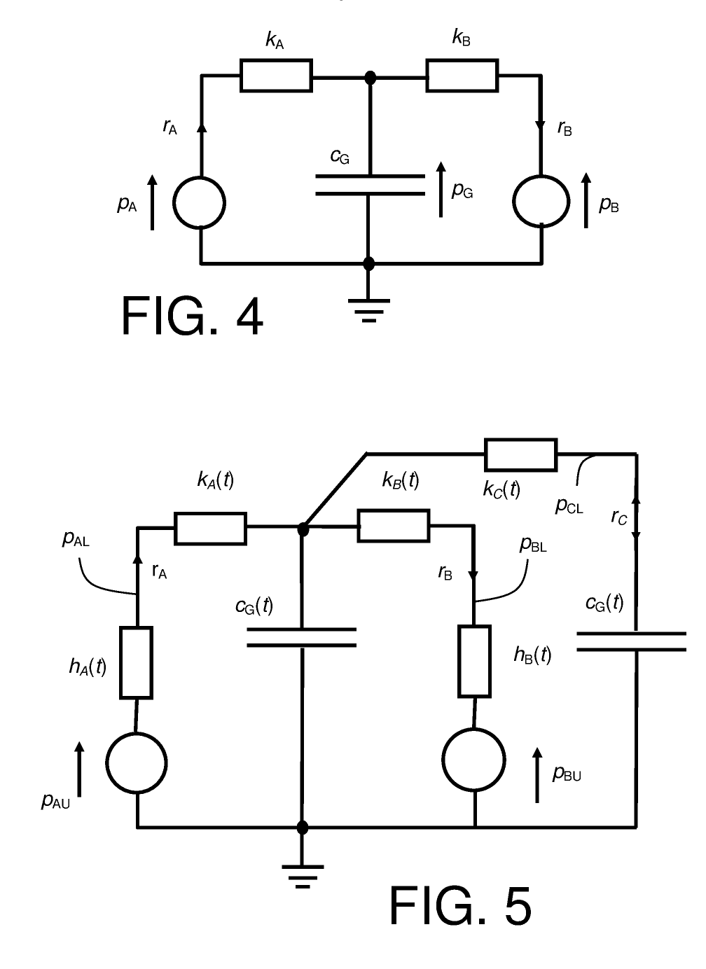

FIG. 4 is a parametric representation of an oil well production system which is a gross simplification of a real oil and/or gas well production system. Flow resistance is indicated with k_{A}, k_{B} while spatial capacities are indicated with C_{G}.

FIG. 5 is also a parametric representation of an oil well production system which is a gross simplification of a real oil and/or gas well, but now includes a deposit not penetrated by any well but in hydraulic communication with the rest of the well system. k_{C} denotes flow resistance to/from the indicated two deposits. r_{B} denotes the related flow to/from said deposit. Parameters with a (t) suffix indicate time dependent parameters.

In practice, pressures can be conveniently measured at top and bottom regions of the wells 80; these pressures will be referred to as p_{AU} and p_{AL} for the well 80A, and p_{BU} and p_{BL} for the well 80B. Moreover, the wells 80A, 80B will themselves represent flow resistance h_{A}, h_{B} respectively to fluid flow therethrough.

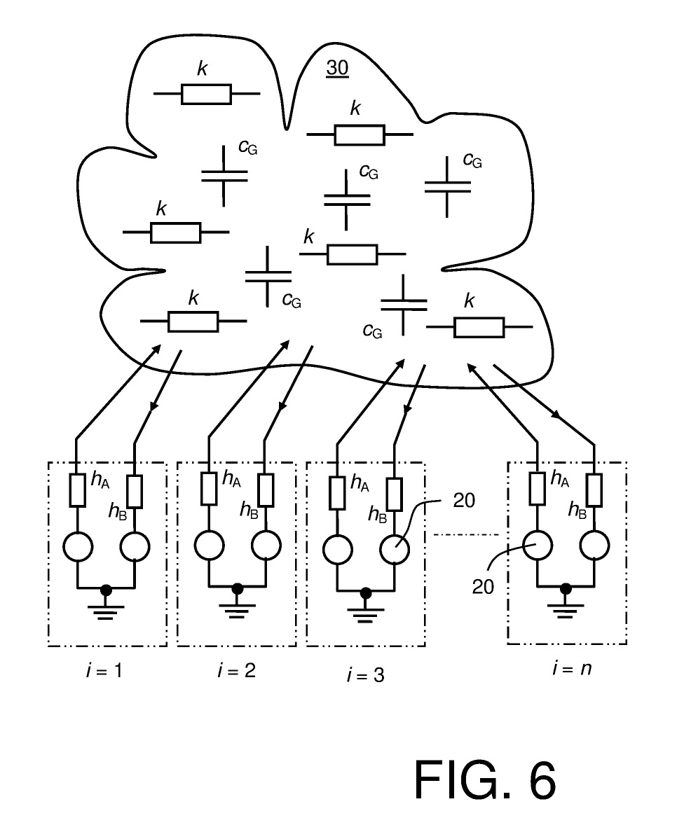

It will be appreciated that optimal control of system as depicted in FIG. 6 is highly complex, for example on account of the pressure p_{G} within the geological formation 30 being a function of spatial location within formation 30. Conveniently, the pressure p_{G} within the formation 30 is defined by P_{G}(x, y, z, t) wherein z, y, z are Cartesian coordinates for defining a region including the formation 30, and t denotes time.

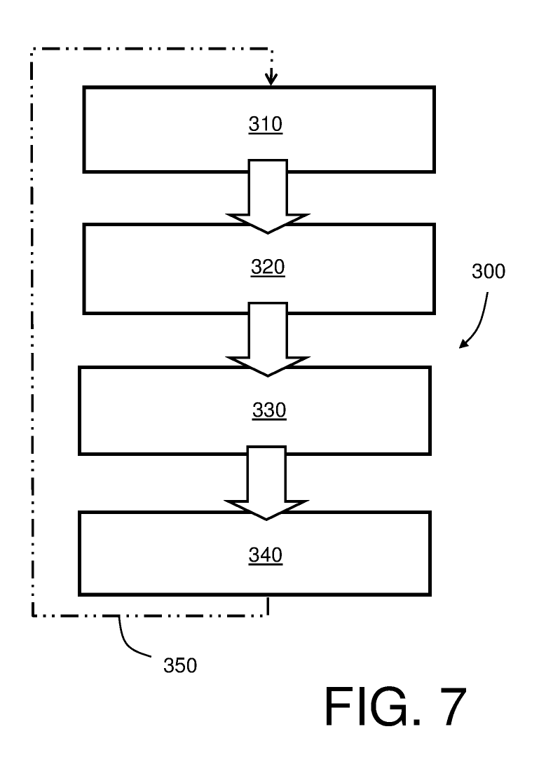

The present invention employs, in overview, a form of algorithm 300 as depicted in FIG. 7. The algorithm 300 includes:

(a) a first function 310 concerned with historical values of measured parameters, for example flow rate “Q” (which is representative of the flow rate r), pressure P (representative of one or more of the pressures p_{AU}, p_{AL}, p_{BU}, p_{BL});
(b) a second function 320 concerned with a conversion of measured parameters from the first function 310 to corresponding working indirect or abstract parameters, e.g. p_{CL}, c_{G} and k_{C} for use in the algorithm 300;
(c) a third function 330 concerned with employing in the parametric representation an estimation algorithm for estimating the behaviour of the facility 10 by processing converted parameters from the second function 320; and
(d) a fourth function 340 concerned with response modelling and prediction based upon parameters from the third function 330.

The functions 310, 320, 330, 340 are optionally executed concurrently and feed data between them on a continuous basis. Alternatively, the functions 310, 320, 330, 340 are executed in sequence which is repeated by way of a return 350 from the fourth function 340 back to the first function 310.

A Kalman filter is a mathematical method which uses measurements that are observed in respect of time t that contain random variations, namely “noise”, and other inaccuracies, and produces values that tend to be closer to true values of the measurements and their associated computed values. The Kalman filter produces estimates of true values of measurements and their associated computed values by predicting a value, estimating an uncertainty of the predicted value, and then computing a weighted average of the predicted value and the measured value. Most weight in the Kalman filter is given to the computed value of least uncertainty. Estimates produced by Kalman filters tend to be closer to true values than the original measurements because the weighted average has a better estimated uncertainty than either of the values that went into computing the weighted average.

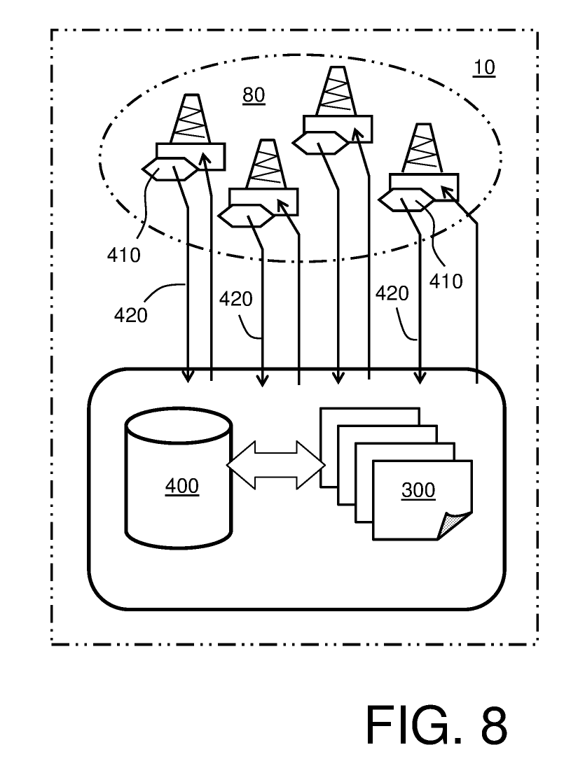

Referring to FIG. 8, the algorithm 300 is based on a Kalman filter formulation of an oil and/or gas production system having Nᵢ injectors and Nₚ producers. Downhole distal pressure measurements p_{LA}, p_{LB} as well as wellhead proximate pressure measurements p_{UA}, p_{UB} in the injector and producer wells 80A, 80B are made available to the algorithm 300. In certain situations, only wellhead proximate pressures p_{UA}, p_{UB} are measured and corresponding data is supplied to the algorithm 300. The algorithm 300 is also provided with measurements of injection and production flow rates r_{A}, r_{B} as a function of time t. The injection and production flow rates r_{A}, r_{B} are beneficially measured using at least one of: ultrasonic measurement sensors, electromagnetic measurement sensors, pressure difference sensors associated with a flow resistance (for example a flow orifice or section of pipe).

The algorithm 300 is thus operable, via its Kalman filter, to compute estimates of parameters including:
(i) productivities and injectivities of the wells 80 of the gas and/or oil production system;
(ii) storage characteristics and/or change in average reservoir pressure of the geological formation 30;
(iii) interactivities between wells 80 of the system; and
(iv) aquifer influx and/or “out-of-zone” outflux in respect of the geological formation 30 and its associated wells 80.

The algorithm 300, namely implemented in computing hardware 400 and sensing instruments 410 coupled thereto, has technical effect in that it senses physical conditions of the system as sensed signals, analyses the signals, and then generates outputs which can be used for controlling operation of the system to improve its productivity, increase operating safety and/or reduce maintenance costs. Improved operating safety is achieved by more appropriate control which assists to avoid blowouts, fractures and similar. Enhanced productivity is achieved by employing a more suitable injectivity strategy. Reduced maintenance can be achieved by maintaining appropriate productivity rates and/or injectivity rates for avoiding sedimentation which can block wells 80 and which is costly and time-consuming to rectify.

Although use of the algorithm 300 is described in relation to oil and/or gas production, it can also be used for controlling other types of industrial processes and also mining operations, for example continuous seabed suction systems for extracting valuable minerals from ocean floor sediments and silt; such ocean mining processes must maintain appropriate flow rates and move extraction nozzles to most valuable mineral deposits in a dynamic real-time basis, namely activities which are advantageously controlled by using computing hardware executing the algorithm 300.

The present invention is susceptible to being used with existing contemporary injection and production wells 80, both in on-shore applications and also in off-shore applications.

Defining a parametric representation or model as presented herein is made possible by introducing the presumption that mass exchange between different deposits in hydraulic communication between them is proportional with the difference in reservoir pressure in the deposits concerned. This makes also possible monitoring cross flow between different deposits and the development of reservoir pressure in participating deposits not being penetrated by wells (“passive deposits”) and consequently do not involve direct pressure measurements.

There are several advantages with this approach, among these are:
Since this invention results in a continuous and concurrent estimation of both well parameters (e.g. productivity and injectivity) and reservoir parameters (e.g. storativity, reservoir pressure and hydraulic communication), estimated well parameters are likewise corrected according to changes in reservoir parameters (e.g. reservoir pressure)
The use of direct measurements as opposed to derived parameters
Availability of the strength of hydraulic communication and the extent of mass transport between different deposits that are comprised in the parametric representation of the sub surface production system
Availability of estimated reservoir pressure in participating deposits that are not penetrated by wells (“passive deposits”) and consequently do not have directly measured pressure measurements available
Availability of indications if the sub surface production system changes character, i.e. novel hydraulic communications to new deposits as well as development of known deposits

The present invention utilizes some novel approaches to enable said parameter estimation:
A multi well and multi deposit parametric description of the hydraulic responses of the variables comprised in a sub-surface production system. This is defined as a plurality of deposits, each participating deposit may have none, one, or a plurality of wells and may be in hydraulic communication with any one of the other deposits.
A parametric description of the relation between pressure differences in different deposits and related transportation of mass between the same deposits. This makes possible formulating the hydraulic responses of the wells in a parametric representation with said parameters and employing an estimation algorithm, such as a Kalman filter, in the parametric representation.
For each relevant system description, depending on the number of deposits and how many wells in each deposit being included in the system description in question, and how the different deposits are connected, control theoretical estimation methods (Kalman filter or similar) are used for continuously to select the best estimate from the different parameters and variables comprised in the system description in question.
Measured and estimated values of the variables involved are thereafter compared with each other for different descriptions of the multi well reservoir. Testing of different hypothesis is used to determine a parametric representation which is the least complex one of the evaluated parametric representations capable of estimating the observed variables, such as production rate and pressure, sufficiently accurate. Observed indirect variables are expected to change as time goes on, and in that case often from a less complex parametric representation to one with greater complexity. The precise definition of “sufficiently accurate” may vary, depending on the actual application, but is always defined by the operator in terms of the correlation coefficient R̂2 being larger than a given threshold value. The fall back value is R̂2>0.95. The simplest parametric representation meeting the accuracy criterion is selected as the system model. If none of the available parametric representations meets the accuracy criterion, a monitor presenting the results displays e.g. “No accurate system model found” and then the resulting parametric representation is taken as the parametric representation giving the best fit.

The present invention utilizes similar real time measurement data as in prior art monitoring systems, e.g. WO2012/039626. In a database comprising real time measurement data, such as related values of pressure and production rate for each producing well and similar for each injector. Pressure measurements may be down hole measurements as well as different pressure measurements by the well head. Corresponding to this, the production rate of each single well be measured (e.g. by using multiphase meters) or calculated based upon other measured variables. The physical measurements and storage of such variables and access to them are prerequisites for utilizing the present invention. Most recently employed wells having some production capacity will nevertheless comprise this type of data access and will consequently be candidates for using the method revealed by the present patent application.

One preferred embodiment of the present invention involves a set of parametric representations describing a subsurface production system. Each of these parametric representations involve one or more deposits that may be in hydraulic communication with other deposits comprised in the parametric representation. Each deposit may have none, one or more producing wells or injector wells connected.

A preferred embodiment utilizes mathematical methods such as Kalman filters or similar for estimation of variables and parameters such as e.g. pressure, rate, productivity or injectivity, the storativity of the deposits involved, reservoir pressure and the strength of hydraulic connection, all of which is involved in each of the characterization of each parametric representation describing the production system.

Statistical methods, like e.g. hypothesis testing, are used to select the simplest description of the system, i.e. the simplest parametric representation, presenting a sufficiently accurate and thus an acceptable relationship between measured and estimated values of one or more sets of variables over time.

In one preferred embodiment, measured and estimated values of a variable involved is sufficiently accurate if the correlation coefficient of the estimated value vs. the corresponding measured value has a correlation coefficient larger than 0.93.

In a more preferred embodiment, measured and estimated values of a variable involved is sufficiently accurate if the correlation coefficient of the estimated value vs. the corresponding measured value has a correlation coefficient larger than 0.95.

In all embodiments of the present invention, the production system which is being modeled, may change as time passes. It may then be important to retest a chosen hypothesis in order to find a parametric representation that is sufficiently accurate. This may be the same parametric representation with different parameters or another parametric representation with a different set of deposits and parameters. Hydraulic communication to new deposits may develop over time, or existing hydraulic communication between deposits may change.

1. A production monitoring system for a configuration of oil and/or gas wells, said configuration comprising production and injection wells coupled in operation to sensors for measuring physical processes during normal operation of the production well(s) and injection well(s) and generating corresponding measurement signals for computing hardware, wherein said computing hardware is operable to execute software products for processing said signals,
characterized in that,
the software products are adapted for said computing hardware to analyze said measurement signals to abstract at least one parametric representation of said configuration of oil and/or gas wells, concurrently comprising the following parameters:
one productivity parameter for each production well (BOA);
one injectivity parameter for each injection well;
one storativity parameter for each deposit; and
one connectivity parameter for the hydraulic communication between each pair of deposits in hydraulic communication with each other, and to employ said at least one parametric representation for monitoring the configuration of oil and/or gas wells.

2. A production monitoring system as claimed in claim 1, wherein said analysis involves applying the parametric representation with an estimation algorithm for analyzing characteristics of said measurement signals by using said measurement signals, and determining deviations between said measurement signals and corresponding values from the parametric representation for identifying said parameters of the parametric representation.

3. A production monitoring system as claimed in claim 2, wherein said estimation algorithm employs a Kalman filter.

4. A production monitoring system as claimed in claim 1, wherein said at least one parametric representation comprises one of more deposits not penetrated by wells, in addition to the plurality of deposits comprising production and injection wells.

5. A production monitoring system as claimed in claim 1, wherein said at least one parametric representation comprises at least parametric representations and the parametric representation to be used to model the production monitoring system is selected as the simplest one estimating a correlation coefficient between a measured value and an estimated value of a set of variables in the model sufficiently accurate i.e. with a correlation coefficient greater than 0.93.

6. A production monitoring system as claimed in claim 5, wherein said correlation coefficient is greater than 0.95.

7. A production monitoring system as claimed in claim 1, wherein the parametric representation to be used to represent the production monitoring system is selected by a software product.
